(19) United States
(12) Patent Application Publication
(10) Pub. No.: US 2003/0042392 A1
(43) Pub. Date: Mar. 6, 2003

(54) Fogging unit with a flexible isolation mount

(76) Inventor: James A. Mann, Windermere, FL (US)

Correspondence Address: BEUSSE, BROWNLEE, BOWDOIN & WOLTER, P. A., 390 NORTH ORANGE AVENUE, SUITE 2500, ORLANDO, FL, 32801, US

(21) Appl. No.: 09/947,486

(22) Filed: Sep. 6, 2001

(51) Int. Cl. F16M 13/00

(52) U.S. Cl. 248/610

(57) ABSTRACT

A fogging unit includes a flexible belt mount looped around a motor bracket on a motor and hooked to means for suspending the motor from a support frame. The fogging unit also includes a motor with an impeller attached to a shaft driven by the motor. A bracket is mounted to a motor housing of the motor, and a flexible belt is secured intermediate the bracket and motor housing, and extends above the bracket for attaching the fogging unit to an overhead oscillator or frame structure. A baffle is mounted to a back end of the motor housing in spaced relation to the motor housing to inhibit water from passing through the motor housing.

### FIELD OF THE INVENTION

This invention relates generally to mounting units for suspension and isolation of motors and the like, and more specifically, to the isolation mounting units used to isolate overhead ventilation and water motors as fogging units in propagation, maintenance and protection of plant life from heat and frost.

### BACKGROUND OF THE INVENTION

Fogging units are used in plant nurseries for propagation, maintenance, and protection of plant life, from heat and frost by mounting the fog unit to an existing overhead structure. The use of multiples of smaller fractional horsepower fogging units conserve water by using less water and dispersing fog more efficiently over a larger area than conventional wet pads and larger units. Several small overhead fog units can enhance the performance of existing conventional wet pads and create several isolated micro-climates in a single area, if necessary.

The fogging units generate a centrifugal atomized mist of water to form a fine blanket of fog over plant to avoid damage during freezing temperatures. Most mounting mechanisms used to suspend and isolate fogging units are rigid frames that are mounted directly to a support, or oscillating units, which are fixed to the support. The frames are usually constructed of aluminum or stainless steel to avoid rusting. For this reason, the vibration of the motor and oscillator create a great deal of noise. In addition, the units are cumbersome, difficult to assemble and to adjust the horizontal pitch or attitude of the fogging unit.

A fogging unit is disclosed in U.S. Pat. No. 5,628,488 and discloses a flexible mount for a fogging unit having a block mounted to a motor mounting bracket. A flexible belt extends intermediate the block and bracket forming two looped ends which are hooked to a eye bolt for securing the fogging unit on a frame. The motor illustrated in the '488 patent has a totally enclosed frame in which a fan is mounted for cooling the motor. However, such a motor unit tends to operate hotter, which is an unnecessary inconvenience of operation of a fogging unit.

### SUMMARY OF THE INVENTION

It is the general aim of this invention to provide an easily assembled flexible isolation mounting unit. It is the further object of this invention to provide such flexible isolation mount that it is also easily adjustable to control the pitch of a motor unit. Yet another object of this invention is to provide a flexible isolation belt for mounting a ventilation or fogging motor to reduce the sound and vibration level of the fogging motor.

Still another object of the invention is provide a smaller motor unit with an open frame design so the fogging unit operates cooler with less vibration than previous fogging units.

These and other objectives and goals are achieved by utilizing a flexible belt mount looped around a motor bracket on a motor and hooked to means for suspending the motor from a support frame. The fogging unit includes a motor with an impeller attached to a shaft driven by the motor. A bracket is mounted to a motor housing of the motor, and a flexible belt is secured intermediate the bracket and motor housing, and extends above the bracket for attaching the fogging unit to an overhead oscillator or frame structure. The motor is preferably an open frame motor that allows an adequate flow of air through the motor housing to cool the motor. A baffle is mounted to a back end of the motor housing in spaced relation to the motor housing to inhibit water from passing through the motor housing.

### BRIEF DESCRIPTION OF THE DRAWINGS

FIG. 1 is a perspective view of a fogging unit.

FIG. 2 is a side elevational view of a fogging unit with the flexible isolation mount.

### DETAILED DESCRIPTION OF THE INVENTION

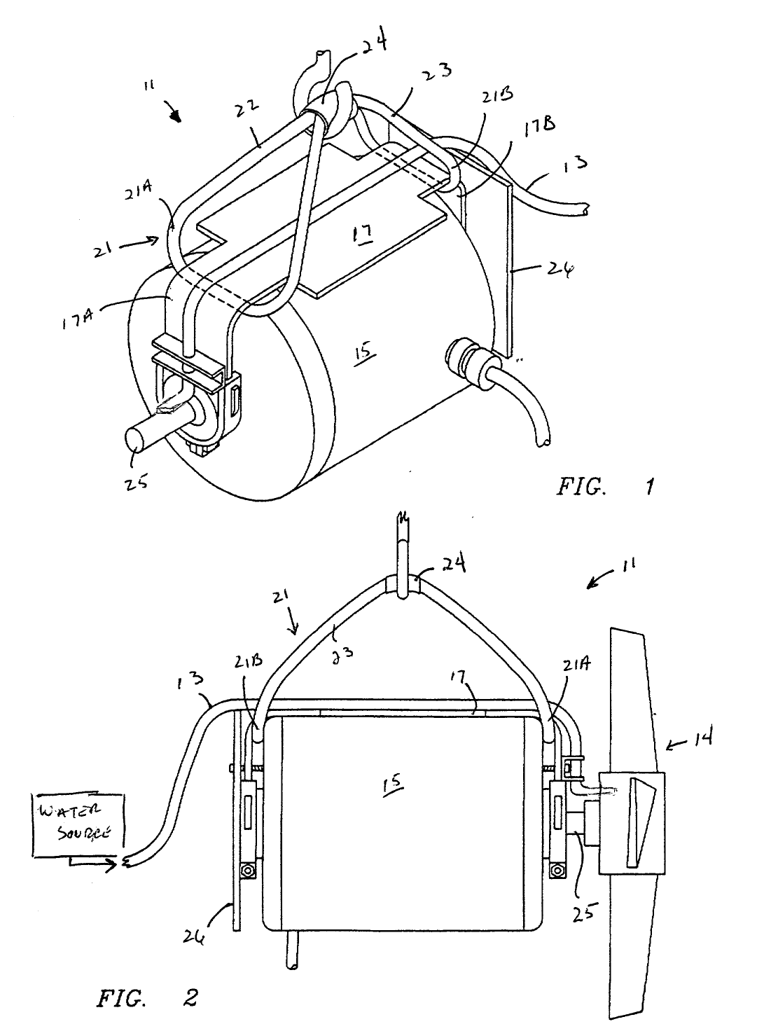

The fogging unit 11, illustrated in FIGS. 1 and 2, suspending from an eye hook bolt 22 thus is attached to an oscillator or overhead structure (not shown). Such a fogging unit generally includes a motor housing 15 with a motor for rotation of the shaft 25. An impeller 14 is mounted to the end of the shaft 25. A water line 13, connected to a remote water source, provides water under pressure and is introduced into the impeller 14 to provide fog generated by centrifugal force. The water line 13 is secured by clamping medium between the base 19 fixed to the housing 15. The longitudinal axis of the motor in the embodiment described in this disclosure is parallel to the shaft 25. The cross-sectional axis of the motor is perpendicular to the longitudinal axis. A baffle 26 is mounted to a back end of the motor housing 15 to inhibit water from entering the motor housing 15. The baffle 26 preferably is a substantially planar member constructed of a rigid rust-resistant material as aluminum or plastic for example.

Although the disclosure of this invention teaches the use of the invention as it relates to micro-fogging units, this invention is not limited to such use of a flexible isolation mount, but may include the use of this isolation mount to any motor unit that may require an isolated or suspended mount.

As shown in FIGS. 1 and 2, the fogging unit 11 includes a flexible belt 21 connected to the fogging unit by bracket 17 on the motor housing 15. The flexible belt 21 used with a one-third horse power unit, has a one-quarter inch square cross section that will support up to three hundred pounds.

The flexible belt 21 is secured between the bracket 17 and motor housing 15. The bracket 17 has a first end 17A adjacent to the impeller 14 and to a second 17A adjacent a back end of the motor housing 15. The flexible belt has a first end 21A extending between the first end 17A of the bracket 17. A second end 21B of the flexible belt 21 extends between the second end 17B of the bracket 17 and the housing. In this manner, an intermediate portion 21C of the flexible belt 21 extends above the motor housing 17 and bracket 17 for attachment to a support frame.

The intermediate portion of the flexible belt 21 includes sections 22 and 23, extending over the housing 15. In a preferred embodiment, the two sections 22 and 23 are clamped together to form an engagement portion 24 on the flexible belt 21 for attaching the fogging unit 11 to an overhead structure. The placement of the engagement portion 24 along sections 22 and 23 will effect the pitch of the motor during operation.

As the motor is activated, the operation of the impeller 14 creates a thrust. The impeller also causes a centrifugal force that causes torsional movement of the motor. Upon activation, the motor will tilt upward to an angle of approximately 5°. The flexible belt counters the upward tilting motion so the attitude of the motor is adjusted so the shaft is approximately 10° below horizontal. The placement of the engagement portion along the length of the sections 22 and 23 will determine the amount of pitch adjustment. If the engagement portion 24 is closer to the impeller, the pitch is adjusted less; and if the engagement portion 24 is placed toward the back end of the motor housing 15, the pitch is adjusted more downward. The engagement portion 24 is preferably centered over the housing to obtain an optimal pitch of 10°.

While this specification discloses the best mode contemplated for carrying the present invention, it will be apparent that modifications or variations may be made without departing from what is regarded to be the subject matter of the invention as set forth in the appended claims.

What I claim is:

1. A fogging unit, comprising:
(a) a motor mounted within a motor housing, and an impeller mounted on a shaft driven by said motor;
(b) a mounting bracket attached to the motor housing, said bracket having a first end adjacent the impeller and a second end adjacent a back end of the motor housing;
(c) a flexible belt secured intermediate the bracket and the motor housing, wherein said flexible belt has a first end extending intermediate the first end of the bracket and motor housing, and a second end extending intermediate the second end of the bracket and motor housing; and,
(d) said flexible belt having an intermediate portion integral the first end and the second end of the belt, and said intermediate portion extending over said motor housing.

2. The fogging unit of claim 1 wherein said intermediate portion of the flexible belt includes two belt sections clamped together forming an engagement portion on the flexible belt.

3. The fogging unit of claim 1 further including a baffle mounted in spaced relation to said back end of the motor housing.

4. A fogging unit, having a motor mounted within a motor housing, and an impeller mounted on a shaft driven by said motor, comprising:
a flexible belt having a first end and a second end secured intermediate the bracket and the motor housing, wherein said flexible belt has an intermediate portion integral the first end and the second end of the belt, and said intermediate portion extending over said motor housing.

5. The fogging unit of claim 4 wherein said intermediate portion of the flexible belt includes two belt sections clamped together forming an engagement portion on the flexible belt.

6. The fogging unit of claim 4 further including a baffle mounted in spaced relation to said back end of the motor housing.

7. The method of mounting a fogging unit for operation, wherein said fogging unit includes a motor mounted in a motor housing, and a bracket mounted to the motor housing, comprising the steps of:
(a) securing a first end of a flexible belt between a first end of the bracket and the motor housing;
(b) securing a second end of the flexible belt between a second end of the bracket; and,
(c) clamping together two belt sections of the flexible belt that are integral the first end and the second end of the flexible belt.

8. The method of claim 7 further including the step of attaching the flexible belt on the clamped belt sections to an overhead structure.

9. The method of claim 7 wherein said clamping step includes forming an engagement portion substantially centered over the motor housing.

10. The method of claim 9 further including the step of attaching the flexible belt on the engagement portion of the flexible belt to an overhead structure.
